(19) United States
(12) Patent Application Publication
(10) Pub. No.: US 2006/0056951 A1
(43) Pub. Date: Mar. 16, 2006

(54) Material handling system

(75) Inventors: Jeffrey Todd Williamson, Monroe, LA (US); Thomas E. Guschke JR., Palm Beach Gardens, FL (US); Todd J. Kovi, West Palm Beach, FL (US); George A. Trovato, Palm Beach Shores, FL (US); Charles Henry Worrall, Herriman, UT (US)

Correspondence Address: MICHAEL E. MARTIN, IP SECTION;GARDERE WYNNE SEWELL LLP, 3000 THANKSGIVING TOWER, 1601 ELM STREET, SUITE 3000, DALLAS, TX, 75201, US

(73) Assignee: JEFFREY TODD WILLIAMSON, MONROE, LA (US)

(21) Appl. No.: 10/941,567

(22) Filed: Sep. 15, 2004

(51) Int. Cl. B65G 47/90

(52) U.S. Cl. 414/626

(57) ABSTRACT

A material handling system for placing and retrieving palletized loads in densely spaced storage areas utilizing an overhead bridge crane connected to a pallet load handling device by way of lifting cables and a stabilizing mast assembly. The pallet handling devices may include vertically or horizontally movable pallet engaging fork mechanisms mounted on a generally rectangular frame which is operable to be lowered over a pallet load and engaged therewith by way of the fork mechanisms. The pallet handling device frame may be split and interconnected by actuator mechanisms to facilitate ease of placing the handling devices over a pallet load and releasing the load from the handling device.

### BACKGROUND OF THE INVENTION

Material handling operations by various business entities, including grocery and merchandise retailers comprise a substantial business cost. Typically, when moving goods from a manufacturing source to a retail store shelf, the goods will be handled many times and incur costs accordingly. Thus there has been an ever present need to improve material handling processes and equipment. Use of high density storage and throughput of goods is desirable, particularly if fixturing for supporting palletized loads can be eliminated or substantially reduced. Moreover, elimination of fork lift trucking in the material handling and storage facility is desirable and reduces the storage space required for a given quantity of goods or material. Still further, moving goods on pallets mechanically is desirable.

For example, in the overall course of events for delivery of goods from a manufacturer to a retail store customer, typically, the manufacturer delivers goods by way of truck or railcar to a warehouse or distribution center, the goods are unloaded on pallets or are palletized and then placed in storage. When delivery to the customer is required, the goods are removed from storage or de-palletized or grouped on pallets with other goods and loaded on vehicles for delivery. One important area of processing goods according to the general description or flow mentioned above is the steps and equipment involved in placing the goods in and removing the goods from high density storage. Historically, these steps and the equipment associated therewith have been the subject of desirable improvements which comprise at least a part of the present invention. However, other improvements in material handling systems and processes are also included in the present invention.

### SUMMARY OF THE INVENTION

The present invention provides an improved material handling system comprising equipment and methods for placing goods in storage and removing goods therefrom. The invention contemplates a system wherein relatively high density storage of goods may be obtained while utilizing little or no storage fixturing. Transport vehicle aisles may be eliminated or substantially reduced and limited forklift truck activity is required since placement and retrieval of pallets of goods or material is provided using unique equipment and devices.

The present invention contemplates a pallet placement and handling system which utilizes overhead crane equipment and pallet handling devices which substantially minimize problems associated with shifting or dropping portions of a pallet load. Several embodiments of pallet handling devices providing so-called pick and place mechanisms are provided in accordance with the invention, each of which may utilize remotely controlled hook or fork devices for engaging a pallet and disengaging from a pallet. In accordance with another aspect of the invention the pallet handling or clamping devices of the invention are advantageously supported by telescoping mast assemblies which are carried by suitable overhead or bridge type crane equipment and are operable to stabilize the devices and loads carried by the devices during load engagement, transport and disengagement. Accordingly, large areas of pallet storage may be provided with dense or closely spaced pallet placement and the hazards normally associated with pallet handling and transport by overhead crane equipment are reduced.

The above-noted features and advantages of the invention together with other important aspects thereof will be further appreciated by those skilled in the art upon reading the detailed description which follows in conjunction with the drawings.

### BRIEF DESCRIPTION OF THE DRAWINGS

FIG. 1 is a perspective view of a material handling and storage system, including the pallet handling equipment of the present invention;

FIGS. 2a and 2b are side elevation views showing one embodiment of a pallet handling device suspended from an overhead crane and utilizing a telescoping guide and stabilizing mast in accordance with the invention;

FIG. 3 is a detail view taken from line 3-3 of FIG. 2b of one embodiment of a telescoping mast for the material handling devices of the invention;

FIG. 4 is a view similar to FIG. 3 of another embodiment of a telescoping mast for use with the material handling system of the invention;

FIG. 5 is an end view of one embodiment of a pallet engaging pivoting fork assembly for use with the pallet handling devices in accordance with the invention;

FIG. 6 is a side elevation of the fork assembly shown in FIG. 5;

FIG. 7 is an end view of another pallet engaging fork assembly for use with embodiments of the pallet handling devices of the invention;

FIG. 8 is a side elevation of the fork assembly shown in FIG. 7;

FIG. 9 is a top plan view of the fork assembly shown in FIGS. 7 and 8;

FIG. 10 is a perspective view of one preferred embodiment of a pallet handling device utilizing the pallet engaging fork assemblies shown in FIGS. 5 and 6;

FIG. 11 is a partial side elevation view of the device shown in FIG. 10 and utilizing the pallet engaging fork assemblies shown in FIGS. 7 through 9;

FIG. 12 is a perspective view of another preferred embodiment of a pallet handling device in accordance with the invention;

FIG. 13 is a side elevation view of the device shown in FIG. 12;

FIG. 14 is a perspective view of still another preferred embodiment of a pallet handling device in accordance with the invention;

FIG. 15 is a side elevation view illustrating the clamp mechanism for the device shown in FIG. 14 in an open position;

FIG. 16 is a side view of a still further preferred embodiment of a pallet handling device in accordance with the invention; and

FIG. 17 is an end view of the device shown in FIG. 16.

### DETAILED DESCRIPTION OF THE PREFERRED EMBODIMENTS

In the description which follows like parts are marked throughout the specification and drawings with the same reference numerals, respectively. The drawing figures may not be to scale and certain features may be shown exaggerated in scale or in somewhat generalized form in the interest of clarity and conciseness.

The present invention is characterized by the various embodiments of the material handling equipment described and illustrated herein which may be advantageously used in a system which includes a warehousing facility for receiving and dispatching motor vehicles carrying various goods to be stored in and removed from the facility. In one embodiment of a system in accordance with the present invention, goods will be delivered to a warehouse facility on standard pallets or will be placed, while in the warehouse facility, on standard pallets of a type specified by the Grocery Manufacturers Association (GMA) and/or provided by CHEP Equipment Pooling Systems, Orlando, Fla. Accordingly, the equipment and processes described herein contemplate utilizing standard size wood, plastic or metal CHEP pallets as the primary goods or material supporting structures and which are operable to be engaged by and disengaged from the pallet handling device embodiments described herein. However, those skilled in the art will recognize that other types of pallets or supporting structures may be utilized while enjoying the benefits of the invention.

Goods received in accordance with the system and method of the invention will be handled by conventional so-called forklift or clamp type trucks for removing material from motor trucks or truck trailers. After performing, receiving and checking tasks, goods may be transported to a palletizing area which may be equipped with automated storage and dispensing equipment for the CHEP pallets. Automated equipment may be utilized to transfer the goods or material to the CHEP pallets. Palletized loads are then transported for putaway via a suitable conveyor. Load stability may be enhanced by stretch wrapping the palletized loads with stretchable plastic-like wrapping material.

After weighing and labeling pallets with appropriate information that can be scanned or read using RFID technology, for example, and checked for compliance required for material handling equipment in accordance with the invention, a pallet load verifying apparatus may be utilized to ensure that the pallet load may be handled by the clamping mechanisms or frames of the devices of the invention. This process may be carried out using an array of photoelectric emitters and receivers and rejected pallets may be diverted onto an exceptions lane for reprocessing.

Once a pallet passes all verifications required, it will be placed on a putaway transport conveyor and a pallet handling device of the invention may be lowered from a bridge crane or hoist, engage the pallet and a load of material or goods thereon and transport it to a desired storage location. Retrieval of the pallet and its load from the storage location may be carried out in a similar manner.

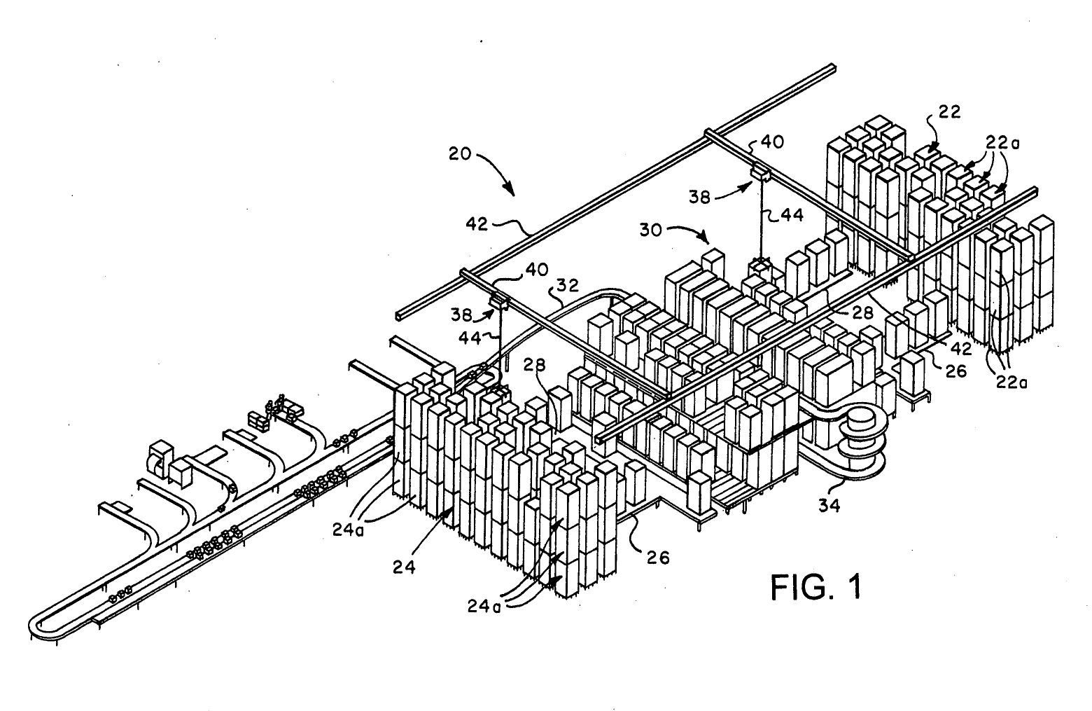

Referring now to FIG. 1, there is illustrated a material handling system in accordance with the present invention for storing pallets of goods in one or more locations in a suitable storage facility or warehouse. As shown in FIG. 1, by way of example, the inventive material handling system is generally designated by the numeral 20 and may be implemented in a facility having space for one or more stacks of pallets, such as pallet stacks 22 and 24 which are spaced apart and are located adjacent respective inflow and outflow conveyors 26 and 28, for example. Pallet stacks 22 and 24 are dense, do not require aisles for traversal of fork trucks, for example, and do not require substantial fixturing or pallet support structures. Pallet loads 22a and 24a may be stacked two or three full pallets vertically, as shown, or more than three partial pallets vertically. An area 30 between the pallet stacks 22 and 24 may be used for breaking down pallet loads or assembling pallet loads and may include distribution conveyors 32 and 34, for example. In other words, the area between the pallet stacks 22 and 24 may be used for de-palletizing loads and making up orders for goods to be shipped out of the facility at which the material handling system 20 is located. Alternatively, the palletized loads 22a and 24a stacked at the pallet stacks 22 and 24 may also be made up in the area between the stacks.

Pallet load handling is accomplished in part by a somewhat automated system which includes one or more bridge cranes 38, two shown in FIG. 1, which cranes may be of conventional construction and preferably controlled remotely by a central processing unit, not shown. Bridge cranes 38 are supported for movement in a conventional manner on transverse movable bridges 40 which, in turn, are operable to move in opposite directions, respectively, along spaced apart rails 42, as shown in FIG. 1. Each of the bridge cranes 38 may be of conventional construction known to those skilled in the art and may include suitable cable or chain type hoisting mechanism for raising and lowering respective pallet handling devices, various embodiments of which will be described herein in further detail. As further shown in FIG. 1, each of the bridge cranes 38 is also adapted to support a telescoping guide and support mast 44 connected to one of the aforementioned pallet handling devices.

Accordingly, the bridge crane arrangement illustrated in FIG. 1 allows for positioning of pallets of goods with respect to the pallet stacks 22 and 24 as well as the work area between the pallet stacks, as desired. Positioning control in all three axes, that is horizontal positioning and vertical positioning may be carried out simultaneously or independently during crane movement as long as suitable clearance is maintained with respect to the stacked pallets or other structures disposed between the stacks 22 and 24.

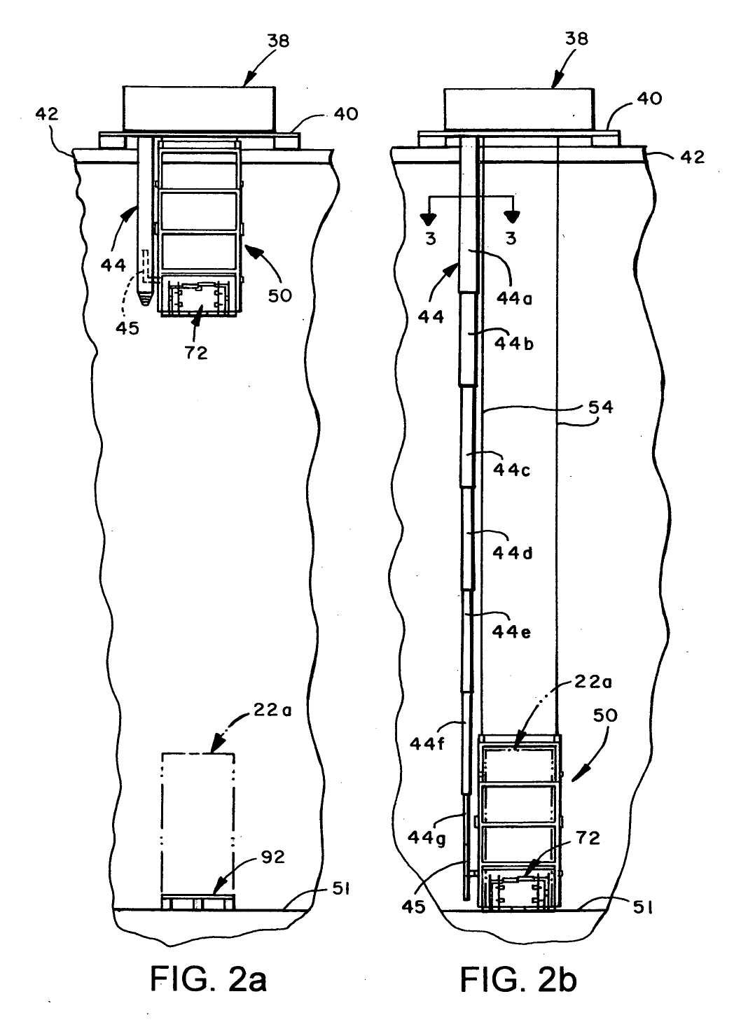

Referring now to FIG. 2a, one of the bridge cranes 38 is illustrated in somewhat generalized form and is shown disposed on a bridge 40 for movement therealong in opposite directions. Bridge crane 38 supports a telescoping mast 44 which is connected to a pallet handling device in accordance with the invention and generally designated by the numeral 50. In the position of the pallet handling device 50 shown in FIG. 2a, the crane 38 has hoisted the device to its maximum lifted position and the telescoping guide and support mast 44 is in a completely retracted or telescoped position. The mast 44 includes a suitable connecting bracket 45 for connecting the mast to the pallet handling device 50. In FIG. 2a, the device 50 is disposed above and vertically aligned with a pallet load 22a, as shown.

Referring to FIG. 2b, in this view the pallet handling device 50 has been lowered to a floor 51 of the facility at which pallet handling is occurring, and has been disposed over and connected to the pallet load 22a, for example, to substantially encompass same. As shown in FIG. 2b, the bridge crane 38 is connected to the pallet handling device 50 by plural depending flexible cables, wire ropes or chains 54 in a conventional manner. As also shown in FIG. 2b, the telescoping mast 44 is shown in its extended position and is characterized by a series of interconnected members 44a, 44b, 44c, 44d, 44e, 44f and 44g. The telescoping mast assembly 44 is operable to stabilize the pallet handling devices of the invention, including the device 50, to allow it to move only substantially vertically with respect to the bridge crane 38 for precise placement of a pallet of goods and for pickup of a pallet of goods, respectively. Accordingly, damping of the movement of the pallet handling device 50 will minimize waiting time between pallet handling operations, reduce the chances for load destabilization and improve precision of placement of a pallet. Mast assembly 44 may also serve to support elongated power and control conductors and/or conduits, not shown, for operating the device 50.

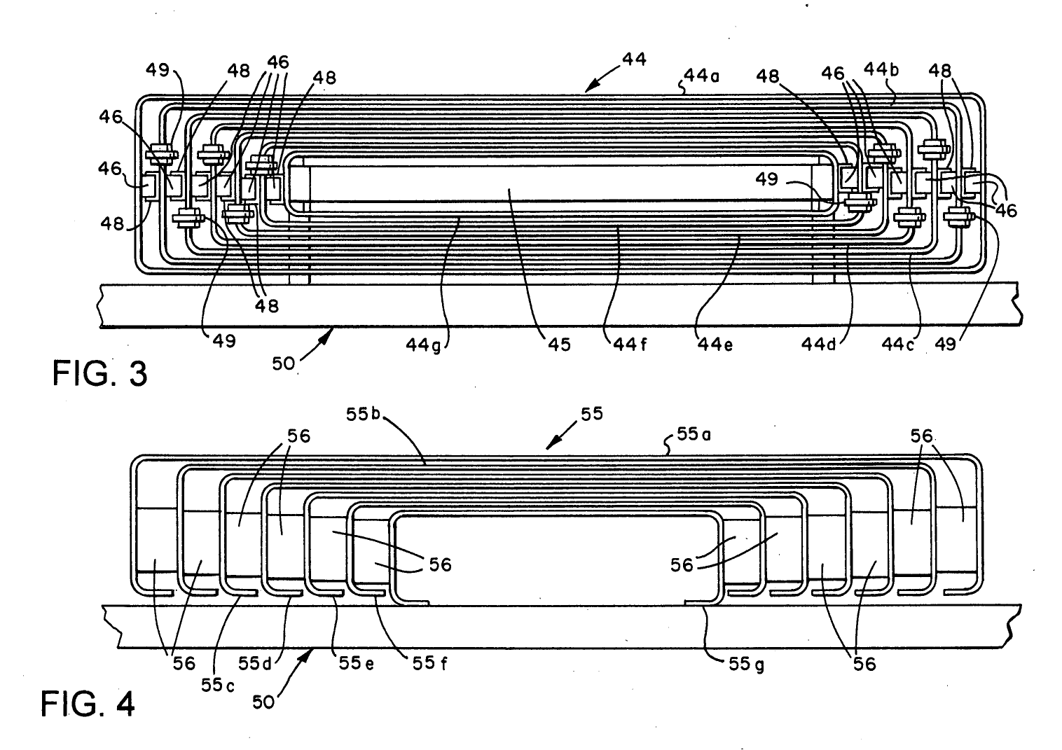

Referring to FIG. 3, the telescoping mast assembly 44 is shown in a cross-section view in further detail. The telescoping mast members 44a through 44g are centralized with respect to each other and adapted for sliding movement with respect to each other by elongated bearing blocks 46 which are mounted on the respective members 44a through 44f and are slidable in elongated channel members 48 mounted on the adjacent mast members, respectively, on opposite sides thereof, as illustrated in FIG. 3. The bearing blocks 46 may be formed of a suitable self-lubricating plastic material, for example. Still further, respective ones of the mast members 44b through 44f are provided with suitable rollers 49 mounted thereon spaced apart along the length thereof and on opposite sides thereof, as illustrated, and are also operable to engage the adjacent mast members to provide for guidance and stabilization of each mast member with respect to the adjacent mast member, respectively.

Referring briefly to FIG. 4, an alternate embodiment of a telescoping mast assembly is shown taken from the same view as the view of FIG. 3 and generally designated by the numeral 55. The mast assembly 55 is provided with telescoping, somewhat channel shaped members 55a through 55g with member 55g being suitably connected to the pallet handling device 50, for example. The mast members 55a through 55g are supported with respect to each other by suitable bearing blocks or rollers 56 disposed on and between adjacent mast members on opposite sides thereof, as illustrated in FIG. 4. As with the bearing blocks 46, the blocks or rollers 56 may be spaced apart along the length of each of the mast members 55a through 55g in sufficient number or length to provide for stability of one mast member with respect to the other so that a substantially rigid mast is provided in various extended or telescoped positions of the mast members.

As mentioned previously, the material handling system 20 is preferably adapted to handle pallets of a conventional type used substantially throughout the material handling industry and provided as CHEP pallets or standard Grocery Manufacturer's Association (GMA) wood, metal or plastic pallets. Custom pallets, including slab pallets, skids and slave pallets may also be handled by the material handling system 20 with minor modifications to the pallet handling devices disclosed and claimed herein. Several embodiments of a pallet handling device disclosed herein are operable to use a pair of opposed tilt-up fork assemblies or rotating fork assemblies, or both, and which will now be described.

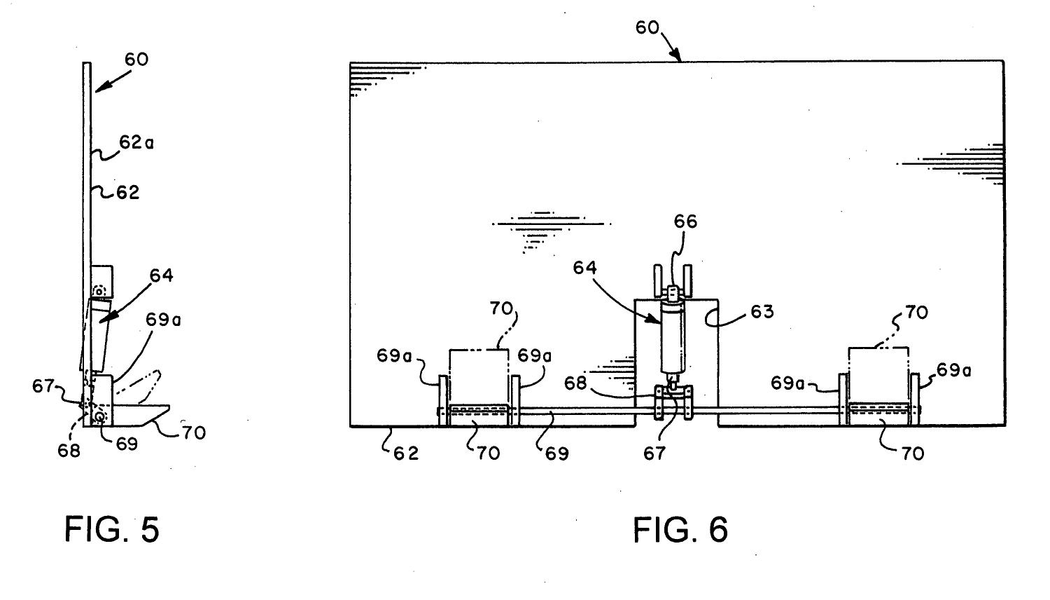

Referring to FIGS. 5 and 6, a tilt-up fork mechanism or assembly in accordance with the invention is illustrated and generally designated by the numeral 60. Each mechanism or assembly 60 is characterized by a metal frame or plate member 62 of generally rectangular configuration and provided with a notch or recess 63, FIG. 6, to provide clearance for an actuator 64, preferably comprising a pressure fluid energized cylinder and piston type actuator pivotally connected to the plate 62 at a pivot connection 66. The piston rod 67 of the actuator 64 is connected to a link 68 which, in turn, is connected to rotatable actuating rod or shaft 69, FIG. 6. Shaft 69 is mounted on plate 62 in spaced apart pairs of bearing plates 69a for rotation in opposite directions and is connected to respective tiltable fork members 70 which may pivot from the position shown in FIGS. 5 and 6, for engaging a pallet to an upward extended position, as shown by the dashed lines in FIGS. 5 and 6, whereby a pallet handling device supporting opposed tilt-up fork assemblies 60 may be moved with respect to the pallet. Accordingly, when the fork members 70 are in a retracted or vertical position, substantially flush with or parallel to a surface 62a of plate 62, see FIG. 5, a pallet handling device supporting the fork assemblies may be moved into or out of engagement with a pallet load 22a or 24a, for example. When the actuator 64 is energized, the fork members 70 may be rotated downward extending horizontally and the assembly 60 may then move upward or laterally, depending on the configuration of a pallet handling device to which the fork assembly is connected, into fork receiving pockets of a pallet for engagement and lifting of same. Release from a pallet is accomplished by generally reversing the above-described process.

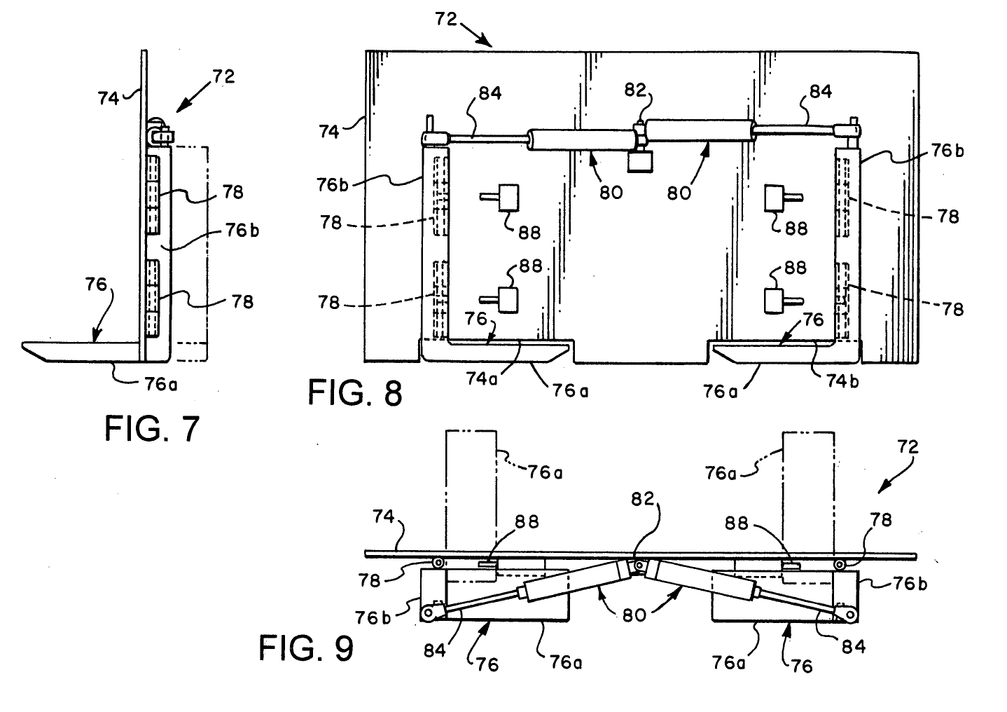

Alternatively, or in addition, the pallet handling devices of the invention may also utilize a rotating pallet engaging fork mechanism, comprising an assembly generally designated by the numeral 72 in FIGS. 7, 8 and 9. The rotating fork assembly 72 is also characterized by a metal plate-like frame member 74. The plate or frame member 74 is adapted to support two spaced apart somewhat L-shaped rotatable fork members 76 which each include a horizontally extending tine 76a and a vertically extending support leg 76b connected to suitable hinge members 78 mounted on plate or frame member 74, respectively. Fork members 76 are rotatable through clearance recesses 74a and 74b in frame member 74, FIG. 8, between the position shown in FIG. 7 and the position shown by solid lines in FIGS. 8 and 9, by actuator means comprising opposed pressure fluid energized piston and cylinder type actuators 80. Actuators 80 are each mounted at one end on plate member 74 at a pivot connecting type mount 82. The piston rods 84 of actuators 80 are connected at their distal ends to the legs 76b of the fork members 76, as shown in FIGS. 8 and 9. Accordingly, when the actuators 80 are energized to extend their piston rods 84, the fork tines 76a are moved to a position parallel to the plate 74 and out of engagement with a pallet. However, when the actuators 80 are caused to retract their respective piston rods 84, the fork members 76 are rotated so that the tines 76a project substantially perpendicular to the plane of the plate-like frame member 74 and into engagement with a pallet. The actuators 80 are, typically, operated synchronized such that both fork members extend together to engage a pallet.

As shown in FIGS. 8 and 9, the rotatable fork assembly 72 may include retractable pin type locks 88 mounted on plate 74 and engageable with the legs 76b of the fork members 76 when the tines 76a are in the working position shown in FIG. 7, and shown as an alternate position in FIGS. 8 and 9. Locks 88 may be operated in conjunction with the actuators 80 in timed relationship such that they engage the legs 76b once the fork members 76 have been rotated to their working position, and release the leg members 76b when the fork members are to be rotated to their retracted or non-working positions, as shown by the solid lines in FIGS. 8 and 9.

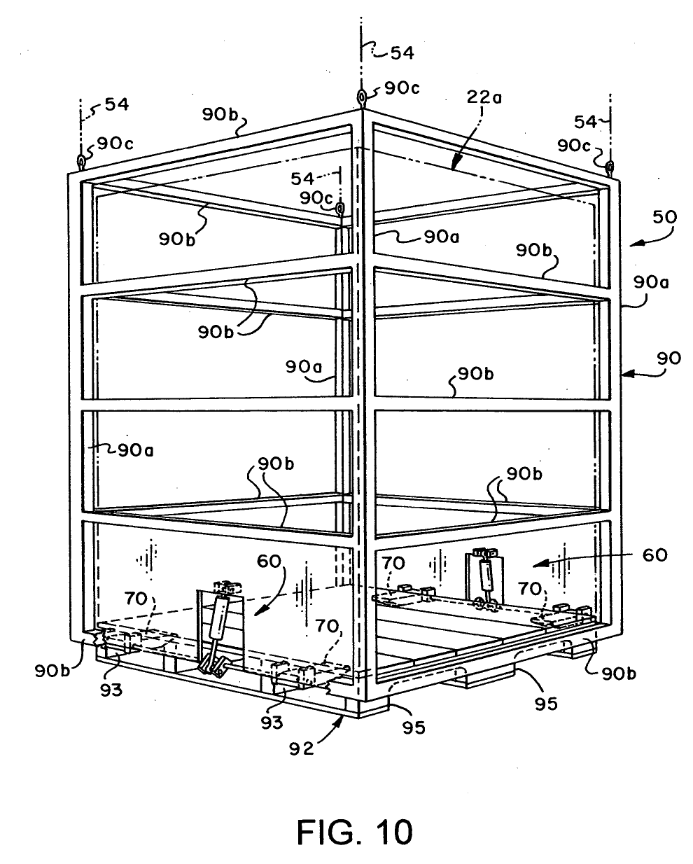

As mentioned previously, a pallet handling device in accordance with the invention may utilize the tilting fork assemblies 60, or the rotating fork assemblies 72, or both. Moreover, a pallet handling device of the invention may take various forms as will now be illustrated and described. Referring to FIG. 10, for example, one embodiment of a pallet handling device is illustrated in further detail and is indicated as the pallet handling device 50 previously illustrated and described. The pallet handling device 50 comprises an open bottom metal frame 90 of generally rectangular configuration and being dimensioned such that the frame may be slipped over a pallet, such as a CHEP or GMA pallet, generally designated by the numeral 92 in the drawing figures, including FIG. 10. The frame 90 is preferably characterized as a rectangular cage preferably formed by spaced apart rectangular cross-section tube or bar vertical frame members 90a and interconnecting horizontal frame members 90b to form a generally rectangular lightweight rigid structure. Four spaced apart crane cable attachment eyes 90c may be placed at the upper corners of the frame 90, as illustrated in FIG. 10.

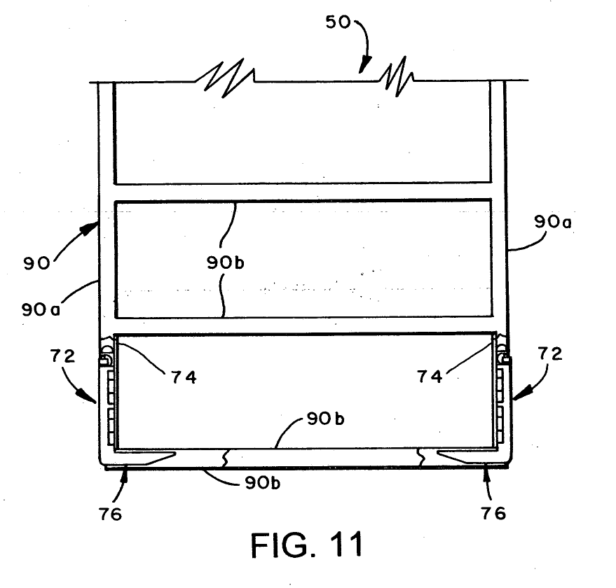

The pallet handling device 50 may include opposed fork assemblies 60 mounted on the frame 90 opposite each other, as indicated in FIG. 10. Alternatively, the frame 90 may be modified or adapted to support opposed rotatable fork assemblies 72, as shown in FIG. 11. The pallet handling device 50 may be suitably connected to the telescoping mast assembly 44 by its bracket 45, as indicated in FIGS. 2a and 2b, and to respective wire ropes, cables or chains 54 of the hoist or crane 38 at the respective lifting eyes 90c. A pallet load 22a, including a pallet 92, may be engaged by the device 50 or disengaged from the device 50 by lowering the frame 90 to a position whereby the fork assemblies 60 or 72 may be activated to engage the pallet 92 or disengage therefrom, as required, for either moving a quantity of goods or material stacked on a pallet 92, or depositing a quantity of goods stacked on a pallet 92. If the fork assemblies 60 are used, the device 50 is lowered to a position whereby the forks 70 may be rotated to their horizontally extending working positions, and then the device is raised slightly so that the forks move into fork receiving pockets 93 or 95 of pallet 92, see FIG. 10, depending on the orientation of the device 50 with respect to pallet 92. The procedure is reversed for disengagement of device 50 from a pallet.

Laser, radio frequency and/or infrared emitting and sensing devices, not shown, may be employed to determine the exact position of each pallet load 22a or 24a and to orient the crane 38 above a so-called targeted load to be moved by the material handling system of the present invention. Once a targeted load is located, the crane 38 is actuated to lower or raise the pallet handling device 50 with respect to the pallet load in question. The pallet handling device 50 may also be equipped with suitable sensors, as noted above, to establish the precise location of the device with respect to the load to be picked up. Once precision orientation of the pallet handling device 50 with respect to the pallet 92 is confirmed, the fork assemblies 60 or 72 are activated to engage the pallet. Suitable sensors may be utilized to confirm engagement and at engagement confirmation, the overhead crane 38 may then lift and move a pallet load to an intended destination.

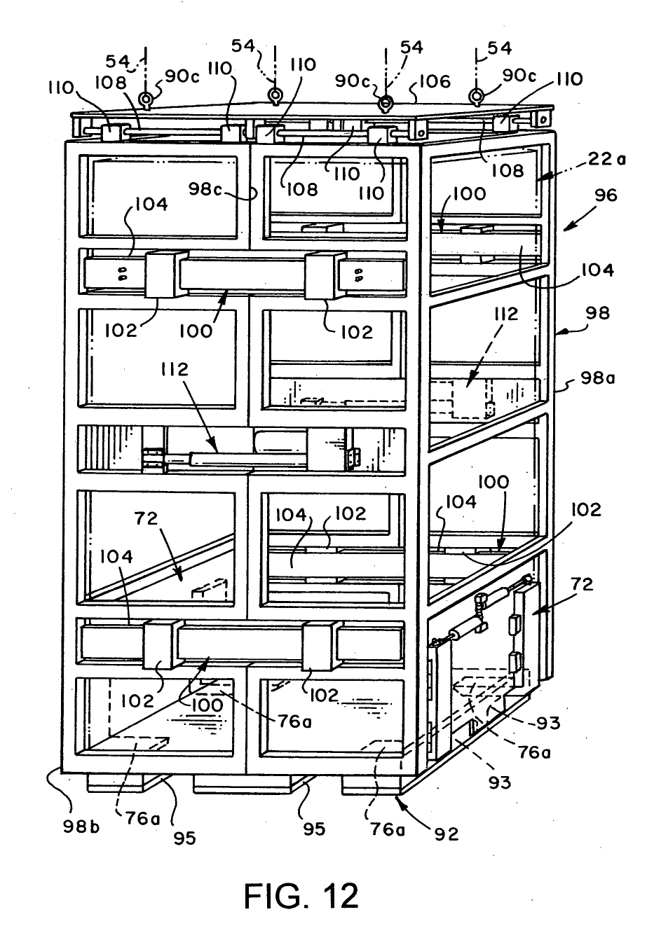

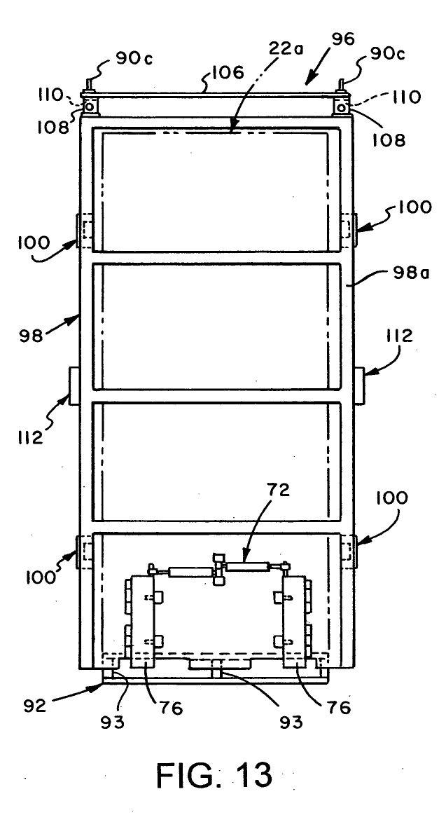

Referring now to FIG. 12, another preferred embodiment of a pallet handling device in accordance with the invention is illustrated and generally designated by the numeral 96. The pallet handling device 96 is characterized by a generally rectangular cage-like open bottom frame 98 similar to the frame 90 in certain respects but formed in separate opposed sections 98a and 98b which are engageable with each other at a vertical parting plane 98c. Cage or frame members 98a and 98b may be constructed of vertical and horizontal metal tube or bar frame members suitably fixed to each other and of construction similar to the cage or frame 90. Frame members 98a and 98b are also interconnected by opposed spaced apart linear bearing and support assemblies 100 interconnecting the frame members 98a and 98b and allowing limited linear movement of the frame members toward and away from each other. The linear bearing assemblies 100 preferably include somewhat channel shaped bearing members 102 mounted on the respective frame members 98a and 98b and engaged with elongated floating frame rails 104, respectively, as illustrated. A lifting plate member 106 is provided with the respective lifting eyes 90c arranged in a rectangular pattern and operable to be engaged with lifting cables 54 of the bridge crane 38. Lifting plate 106 is connected to the frame members 98a and 98b by linear bearing assemblies including spaced apart bearing rods 108, three shown in FIG. 12 which are connected to plate 106 in a standoff position therefrom, respectively. Bearing rods 108 are journalled by bearing blocks 110, respectively, which blocks are connected to respective ones of frame members 98a and 98b, as shown in FIG. 12, to allow for limited linear reciprocating motion of the frame members 98a and 98b with respect to each other and with respect to the lifting plate 106. As further shown in FIG. 12, the pallet handling device 96 utilizes the rotatable fork assemblies 72 mounted opposite each other on each of the frame members 98a and 98b for engagement with a pallet 92, as shown in FIGS. 12 and 13.

Referring still further to FIGS. 12 and 13, the frame members 98a and 98b may be moved relative to each other by spaced apart actuators 112 connected to the respective frame members and operable to move the frame members to separate and to engage the frame members with each other at the parting plane 98c. The actuators 112 may be one of several types, however linear power screw type actuators may be suitable for moving the frame members relative to each other.

Accordingly, the pallet handling device 96 is preferably usable with rotatable fork assemblies 72, although other types including the fork assemblies 60 may be used. Typically, the device 96 is actuated to move the frame members 98a and 98b away from each other a sufficient distance to easily clear a pallet load and its pallet. Once the on-board sensors on device 96 determine that the position of the frame or cage 98 relative to a pallet load 22a is proper, FIG. 13, the rotatable fork assemblies 72 may be actuated to rotate the fork tines 76a into their working positions, as shown in FIGS. 12 and 13, and the actuators 112 are energized to move the frame or cage members 98a and 98b toward each other until they abut at the parting plane 98c. In this position, a crane 38, not shown in FIG. 12 or 13, may be operated to lift and place the pallet load 22a, as desired. The embodiment of the pallet handling device illustrated FIGS. 12 and 13 may, of course, also use the tilt-up fork assemblies 60 in place of the rotatable fork assemblies 72.

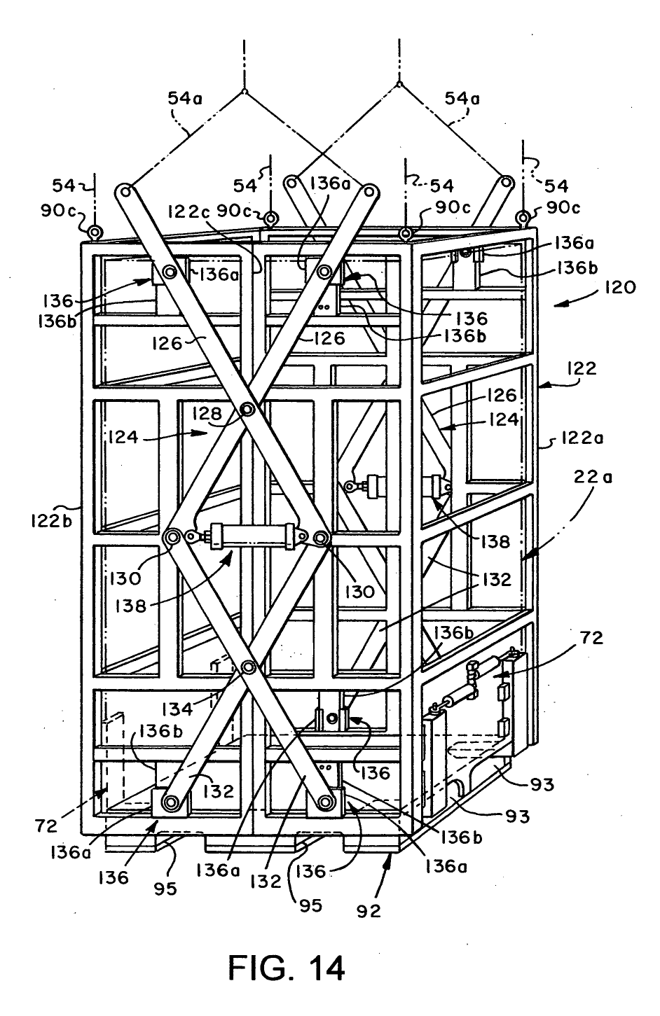

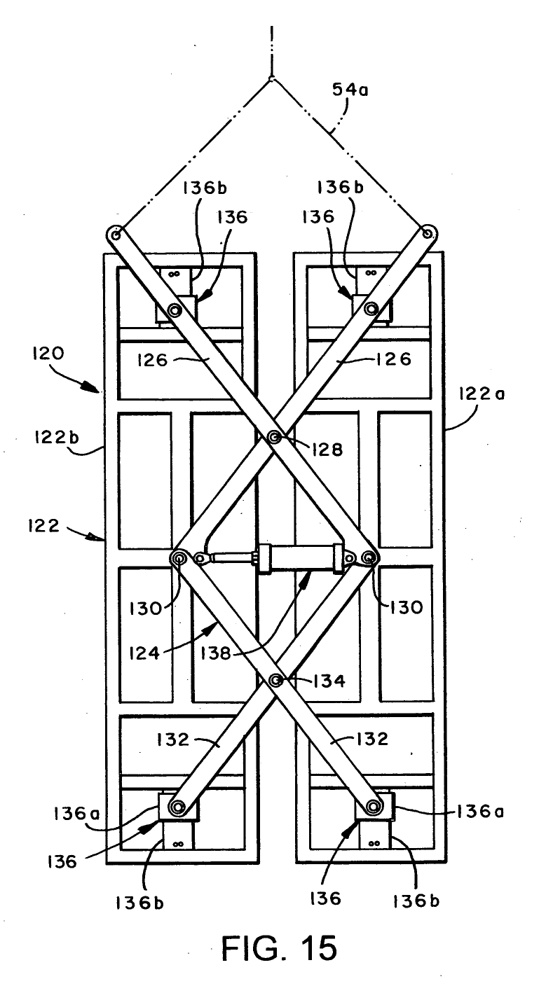

Referring now to FIGS. 14 and 15, another preferred embodiment of a pallet handling device in accordance with the invention is illustrated and generally designated by the numeral 120. The pallet handling device 120 is also characterized by an open bottom, rectangular metal frame or cage 122 formed of two separate adjacent members 122a and 122b which may be positioned contiguous with each other at a parting plane 122c somewhat in the manner of the handling device 96.

The pallet handling device 120 is further characterized by actuating mechanism comprising opposed scissors-like linkages operably connected to the respective frame members 122a and 122b and generally designated by the numeral 124, respectively. The actuating mechanisms 124 each comprise opposed pivotally connected links 126 which are connected to each other at a pivot point 128, FIGS. 14 and 15, and are connected to additional links 132 at pivot points 130, respectively. Links 132 are connected to links 126 at pivot connections 130 and to each other at pivot connections 134, respectively. Links 126 are also pivotally connected to the respective frame or cage members 122a and 122b at linear bearing assemblies 136, which bearing assemblies are similar in some respects to the bearing assemblies 100. Somewhat channel shaped bearing members 136a are pivotally connected to links 126 and 132, respectively, and are engaged with cooperating bearing rails 136b for linear reciprocating movement, therealong. Rails 136b are supported on opposite sides of frame members 122a and 122b, respectively, as shown. Pressure fluid energized cylinder and piston actuators 138 extend between and are connected to respective pairs of links 126 and are operable to effect operation of the actuating mechanisms 124 to move the frame members 122a and 122b laterally with respect to each other to separate sufficiently to lower the handling device 120 over a pallet load 22a. When sensors on the frame 122 determine that the device 120 is properly positioned with respect to a pallet load 22a, a suitable control system may be operated to then cause operation of the cylinder actuators 138 to effect operation of the scissors-like actuating mechanisms 124 to move the frame members 122a and 122b to be substantially contiguous with each other at the vertical parting plane 122c to clamp and enclose the pallet load. The rotatable fork mechanisms 72 mounted on the respective frame members 122a and 122b may be actuated to position their respective forks tines 76a such as to engage a pallet 92, before or after the frame members are moved toward each other in the manner described above.

As shown in FIG. 14, the crane lift cables 54 may be attached to corners of the frame members 122a and 122b at lifting eyes 90c, respectively. Alternatively, the lifting cables 54 may be connected to distal ends of the links 126 so that when tension is placed on the cables to lift a pallet load with the handling device 120, the actuating mechanisms 124 are biased to the frame closed position to alleviate any tendency for the frame members 122a and 122b to separate. Alternatively, as shown in FIG. 15, a separate cable arrangement 54a may be provided for connection to the actuating mechanisms 124 to assure that these mechanisms are biased in a direction to close the frame members 122a and 122b together to the position shown in FIG. 14 as compared with the open position of the frame members shown in FIG. 15. As with the embodiments previously described, the tilt-up fork assemblies 60 may be used in place of the rotatable fork assemblies 72 for the pallet handling device 120.

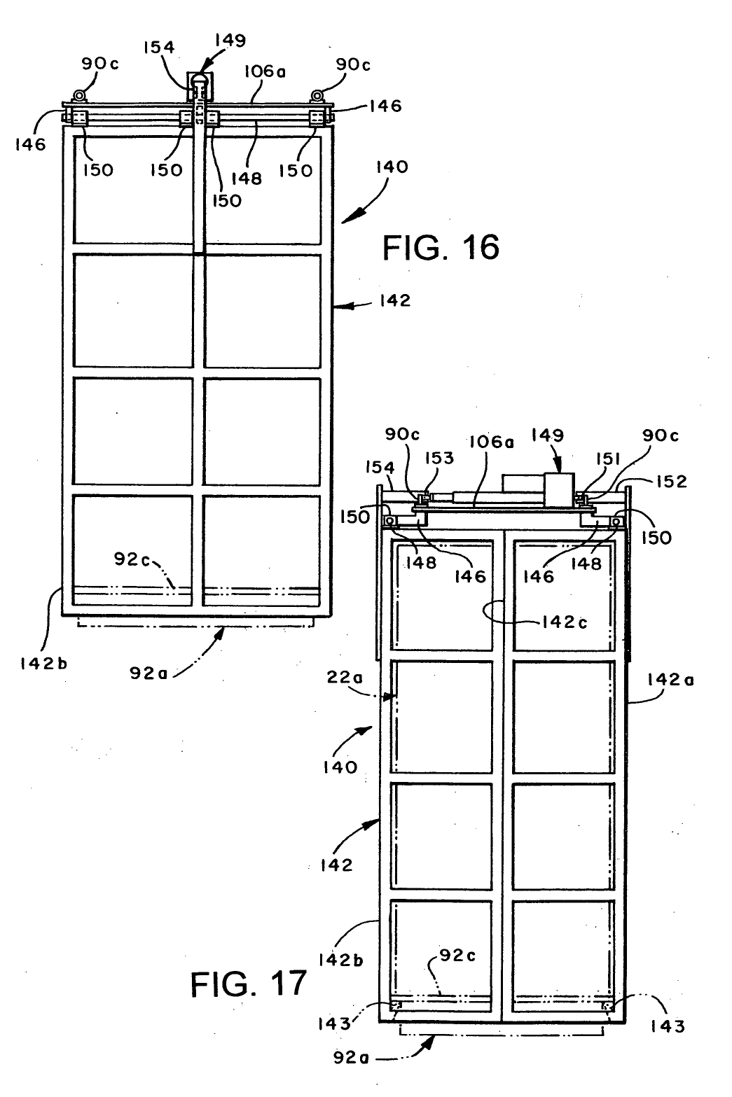

Referring now to FIGS. 16 and 17, a still further preferred embodiment of a pallet handling device in accordance with the invention is illustrated and generally designated by the numeral 140. The pallet handling device 140 is characterized by a rectangular, open bottom cage-like frame 142 similar in some respects to the frames 122 and 98 and having, generally, the same overall dimensions suitable for being lowered over and engageable with a pallet load 22a, FIG. 17. As shown in FIG. 17, the frame or cage 142 is characterized by opposed frame members 142a and 142b which are operable to be engaged with each other at a vertical parting plane 142c. As shown in FIG. 16, a hoisting eye support plate 106a is mounted at the upper end of the frame 142 and includes cable lifting eyes 90c mounted thereon at the corners thereof, respectively. The plate 106a is connected to spaced apart somewhat L-shaped hinge members 146 disposed generally at each corner of the plate member and adapted to support hinge pins 148 therebetween, respectively, as shown by way of example in FIG. 16. Hinge pins 148 are also journalled by hinge members 150 spaced apart on and connected to respective ones of the frame members 142a and 142b, as shown by way of example in FIG. 16 also. Accordingly, the frame members 142a and 142b may pivot about the axes of the hinge pins 148 with respect to each other so that at the bottom ends of the frame members, which include opposed pallet engaging hook portions 143, see FIG. 17, may become engaged with a pallet 92a. Pallet 92a may differ at least slightly from pallet 92 in that a deck member 92c, FIG. 17, is dimensioned so that the hook members 143 may be engaged therewith when the frame members 142a and 142b are pivoted into a position contiguous with each other at the parting plane 142c.

Referring further to FIGS. 16 and 17, actuation of the frame 142 to provide for separation of the frame members 142a and 142b from each other and to bring the frame members together to the position shown in FIG. 17, may be accomplished by a linear power actuator 149 connected to respective ones of the frame members 142a and 142b by opposed angle shaped connecting members 152 and 154, as shown in FIG. 17. Actuator 149 may be of the linear power screw type or may be a pressure fluid actuated cylinder and piston type actuator. The actuator 149 is connected to the members 152 and 154 at suitable pivot connections 151 and 153, FIG. 17. Accordingly, the pallet handling device 140 may be actuated to pivot the frame members 142a and 142b away from each other in response to operation of the actuator 149 whereby the device 140 may then be lowered over a pallet load 22a mounted on the pallet 92a, or a pallet 92, and, when suitable sensors on the frame 142 determine that the frame is properly positioned with respect to the load, the actuator 149 may then be operated to move the frame members 142a and 142b into a position contiguous with each other to clamp the load and to cause the hook parts 143 to be engaged with the pallet. The pallet handling device 140 is thus also operable in a manner substantially like operation of the pallet handling devices 96 and 120, in particular.

Those skilled in the art will appreciate from the foregoing that the material handling system of the present invention may utilize one or two pallet storage and retrieval zones, such as the pallet stacks 22 and 24, FIG. 1, and the system described herein is applicable for other arrangements also. Only the material infeed and outfeed subsystems would typically require to be modified for particular types of material or goods being handled. Moreover, through-put of each storage and retrieval zone or stack 22 and 24 will possibly be limited only by the overhead bridge crane travel speeds and the speed of moving the pallet handling devices between placement or pickup positions and transport positions. Typically, the material handling system 20 would stack loads up to a maximum unsupported stack height as allowed by local fire hazard codes, typically three full pallets. However, with a one pallet high system, the concept provides for dense storage and ready accessibility of individual pallet loads. Thanks to the horizontal x-y axis movement capability of the overhead cranes 38, access to any individual pallet stack is provided without requiring forklift truck or similar vehicle or transport apparatus aisles, as with conventional racked pallet storage systems.

Still further, the system 20 provides a variable level of throughput depending on the number of bridge cranes 38 and crane operating speeds. As mentioned previously, laser, radio frequency and/or infrared emitting and sensing devices may be employed to determine the exact position of each pallet stack and to orient the bridge cranes 38 above a targeted load. Once the targeted load is located, the pallet handling device being used is actuated to lower over the pallet load and, being equipped with sensors as described above, establish the precise horizontal and vertical position of the load with respect to the pallet handling device. Once proper orientation of the pallet handling device is confirmed, the device is actuated to engage the pallet load, as described above, and the associated sensing devices confirm engagement to a suitable control system. On confirmation of engagement, bridge crane 38 either lifts or lowers to place the pallet load in its retrieval or storage position. Control cables and/or hoses may be trained along the mast assemblies 44 and/or 44a to the respective actuators, sensors and other control elements associated with the embodiments of the pallet handling device.

The material handling system described above and the various embodiments of the pallet handling devices may be constructed using known engineering practices and materials and commercially available components including such elements as bearing assemblies and actuators, for example. Although a preferred embodiment of a material handling system and preferred embodiments of pallet handling devices for such a system are described in detail hereinabove, those skilled in the art will also recognize that various substitutions and modifications may be made without departing from the scope and spirit of the appended claims.

What is claimed is:

1. A material handling system for placing and retrieving pallet loads of material mounted on support pallets, respectively, said system including at least one crane moveable above a stacking area for one or more stacks of pallet loads, said crane being operable to lift and lower a pallet load for placement in or retrieval from a stacking area, said crane being connected to a pallet handling device, said handling device including a frame for substantially encompassing a pallet load, and said handling device including means for engaging a pallet of said pallet load and for lifting and moving said pallet load in response to movement of said crane.

2. The system set forth in claim 1 wherein:
vertical stacks of pallet loads are placed directly adjacent one another whereby each of said pallet loads is moved to and from a storage and retrieval area by said crane and said pallet handling device.

3. The system set forth in claim 1 wherein:
said crane is operable to move said pallet handling device and a pallet load in multiple directions horizontally and in opposite directions vertically.

4. The system set forth in claim 3 including:
a telescoping mast assembly interconnecting said crane with said pallet handling device for stabilizing said pallet handling device during movement thereof.

5. The system set forth in claim 4 wherein:
said mast assembly comprises telescoping tubular members of selected dimensions providing for movement of said tubular members telescopically with respect to each other and bearing means on selected ones of said tubular members for engaging adjacent ones of said tubular members to provide for linear telescopic movement without substantial lateral deflection thereof, respectively.

6. The system set forth in claim 4 wherein:
said mast assembly comprises plural telescopically arranged channel members dimensioned to be telescopically disposed one within the other and bearing means on said channel members for minimizing lateral deflection of said channel members with respect to each other.

7. The system set forth in claim 1 wherein:
said pallet handling device includes pallet engaging means thereon for engaging said pallet of said pallet load in response to moving said pallet handling device into a position, substantially encompassing said pallet load.

8. The system set forth in claim 7 wherein:
said pallet engaging means comprises opposed fork mechanisms including spaced apart fork members mounted on a support disposed on said pallet handling device and moveable between a retracted position and a working position for engaging a pallet, and actuator means for moving said fork members between said working and retracted positions.

9. The system set forth in claim 8 wherein:
said fork members are connected to a shaft for pivoting said fork members between a generally vertical retracted position and a generally horizontally extending working position, respectively.

10. The system set forth in claim 9 wherein:
said actuator means comprises a cylinder and piston actuator connected to said shaft.

11. The system set forth in claim 8 wherein:
said fork members are mounted on said support for pivotal movement generally horizontally between retracted positions and working positions about respective hinge axes and said actuator means comprises opposed actuators connected to said support and to respective ones of said fork members for moving said fork members between said retracted and working positions, respectively.

12. The system set forth in claim 7 wherein:
said pallet handling device includes a generally rectangular cage-like frame supporting opposed pallet engaging fork mechanisms, said frame being operable to be lowered over a pallet load by said crane and engaged with a pallet by way of said fork mechanisms, respectively, for lifting a pallet load.

13. The system set forth in claim 12 wherein:
said frame of said handling device comprises opposed interconnected frame members and said frame members are operable to be moved toward and away from each other for encompassing and clearing a pallet load, respectively.

14. The system set forth in claim 13 wherein:
said frame members are interconnected by actuator means for moving said frame members toward and away from each other, respectively.

15. The system set forth in claim 14 wherein:
said actuator means comprises a scissors mechanism including opposed links connected to respective ones of said frame members and an actuator connected to said links for moving said frame members toward and away from each other.

16. The system set forth in claim 15 wherein:
said links are connected to linear bearing means mounted on said frame members, respectively, for moving said frame members toward and away from each other in response to movement of said scissors mechanism.

17. The system set forth in claim 16 including:
cable actuating means for biasing said scissors mechanism to move said frame members toward each other to encompass a pallet load.

18. The system set forth in claim 16 including:
an actuator connected to said links and operable for moving said frame members toward and away from each other through movement of said links.

19. The system set forth in claim 13 wherein:
said frame members are interconnected by a linear bearing means and actuator means for moving said frame members substantially linearly toward and away from each other for encompassing and clearing a pallet load, respectively.

20. The system set forth in claim 19 wherein:
said fork mechanisms are mounted on respective ones of said frame members.

21. The system set forth in claim 13 wherein:
said frame members are pivotally connected to a support member for movement toward and away from each other and said handling device includes an actuator connected to respective ones of said frame members about respective hinges for pivotal movement toward and away from each other.

22. The system set forth in claim 21 wherein:
said frame members each include pallet engaging hook parts disposed thereon at a lower part thereof, respectively, for engaging a pallet in response to movement of said frame members toward each other.

23. A pallet handling device for a material handling system for placing and retrieving pallet loads of material mounted on support pallets, respectively, said handling device being adapted to be connected to lifting and lowering crane means and including a frame for substantially encompassing a pallet load and said handling device including extendable and retractable means for engaging a pallet of said pallet load and for lifting and moving said pallet load in response to movement of said crane means.

24. The device set forth in claim 23 wherein:
said engaging means is operable for engaging said pallet of said pallet load in response to moving said handling device into a position, substantially encompassing said pallet load.

25. The device set forth in claim 24 wherein:
said engaging means comprises opposed fork mechanisms including spaced apart fork members mounted on a support disposed on said handling device and moveable between a retracted position and a working position for engaging a pallet, and actuator means for moving said fork members between said working and retracted positions.

26. The device set forth in claim 25 wherein:
said fork members are connected to a shaft for pivoting said fork members between a generally vertical retracted position and a generally horizontally extending working position, respectively.

27. The device set forth in claim 26 wherein:
said actuator means comprises a cylinder and piston actuator connected to said shaft.

28. The device set forth in claim 25 wherein:
said fork members are mounted on said support for pivotal movement generally horizontally between retracted positions and working positions about respective hinge axes and said actuator means comprises opposed actuators connected to said support and to respective ones of said fork members for moving said fork members between said retracted and working positions, respectively.

29. The device set forth in claim 25 wherein:
said frame comprises opposed interconnected frame members and said frame members are operable to be moved toward and away from each other for encompassing and clearing a pallet load, respectively.

30. The device set forth in claim 29 wherein:
said frame members are interconnected by actuator means for moving said frame members toward and away from each other, respectively.

31. The device set forth in claim 30 wherein:
said actuator means comprises a scissors mechanism including opposed links connected to respective ones of said frame members and an actuator connected to said links for moving said frame members toward and away from each other.

32. The device set forth in claim 31 wherein:
said links are connected to linear bearing means mounted on said frame members, respectively, for moving said frame members toward and away from each other in response to movement of said scissors mechanism.

33. The device set forth in claim 32 including:
an actuator connected to said links and operable for moving said frame members toward and away from each other through movement of said links.

34. The device set forth in claim 29 wherein:
said frame members are interconnected by linear bearing means and actuator means for moving said frame members substantially linearly toward and away from each other for encompassing and clearing a pallet load, respectively.

35. The device set forth in claim 29 wherein:
said frame members are pivotally connected to a support member for movement toward and away from each other and said handling device includes an actuator connected to respective ones of said frame members about respective hinges for pivotal movement toward and away from each other.

36. The device set forth in claim 35 wherein:
said frame members each include pallet engaging hook parts disposed thereon at a lower part thereof, respectively, for engaging a pallet in response to movement of said frame members toward each other.

37. The device set forth in claim 23 including:
a telescoping mast assembly interconnecting said crane means with said handling device for stabilizing said handling device during movement thereof.

38. The device set forth in claim 37 wherein:
said mast assembly comprises telescoping tubular members of selected dimensions providing for movement of said tubular members telescopically with respect to each other and bearing means on selected ones of said tubular members for engaging adjacent ones of said tubular members to provide for linear telescopic movement without substantial lateral deflection thereof, respectively.

39. The device set forth in claim 37 wherein:
said mast assembly comprises plural telescopically arranged channel members dimensioned to be telescopically disposed one within the other and bearing means on said channel members for minimizing lateral deflection of said channel members with respect to each other.
